(19) United States
(12) Patent Application Publication
(10) Pub. No.: US 2011/0167365 A1
(43) Pub. Date: Jul. 7, 2011

(54) SYSTEM AND METHOD FOR AUTOMATED INTERFACE CONFIGURATION BASED ON HABITS OF USER IN A VEHICLE

(76) Inventors: Theodore Charles Wingrove, Canton, MI (US); Michael Dean Tschirhart, Ann Arbor, MI (US); Anthony Ciatti, Ann Arbor, MI (US)

(21) Appl. No.: 12/651,774

(22) Filed: Jan. 4, 2010

(51) Int. Cl. G06F 3/048

(52) U.S. Cl. 715/765

(57) ABSTRACT

An adaptive interface system and a method of configuring a user interface are disclosed. The interface system includes a user interface having a display and a processor for receiving a data relating to a pre-determined trigger event, analyzing the data based upon an instruction set to determine a preference of a user, and reconfiguring the display based upon the preference of the user.

### FIELD OF THE INVENTION

The present invention generally relates to a user interface. More particularly, the invention is directed to an adaptive interface system and a method for configuring a user interface based upon a habit of a user.

### BACKGROUND OF THE INVENTION

When interacting with an in-vehicle infotainment system, users have different usage habits and real-time preferences depending on various factors and trigger events. Certain events include a time of day, a duration of a trip, a repeated commute, and an availability of certain media. Each of the trigger events affect an interaction between the user and a particular device.

Currently, a user must resort to manual configuration of a preset or configurable setting each time an event triggers a change in a habit or preference of the user. There is currently no automated or adaptive interface solution for automotive infotainment systems.

It would be desirable to develop an adaptive interface system and a method for configuring a user interface, wherein the system and the method automatically configure the user interface based upon preference of the user.

### SUMMARY OF THE INVENTION

Concordant and consistent with the present invention, an adaptive interface system and a method for configuring a user interface, wherein the system and the method automatically configure the user interface based upon preference of the user, has surprisingly been discovered.

In one embodiment, an adaptive interface system comprises: a user interface having a display; and a processor receiving a data relating to a pre-determined trigger event, analyzing the data based upon an instruction set to determine a preference of a user, and reconfiguring the display based upon the preference of the user.

In another embodiment, an adaptive interface system comprises: a user interface having a display; a storage device cataloging a data relating to a predetermined event; and a processor receiving the data relating to the pre-determined trigger event, analyzing the data based upon an instruction set to determine a preference of a user, and reconfiguring the display based upon the preference of the user.

The invention also provides methods for configuring a user interface.

One method comprises the steps of: providing a means for collecting a data relating to a pre-determined trigger event; and providing a processor to receive the data, analyze the data based upon an instruction set to determine a preference of a user, and reconfigure the user interface based upon the preference of the user.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of an adaptive interface system according to an embodiment of the present invention;

FIG. 2a is a schematic representation of a display of the interface system of FIG. 1, shown in a default configuration; and

FIG. 2b is a schematic representation of a display of the interface system of FIG. 1, shown in a personalized configuration.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

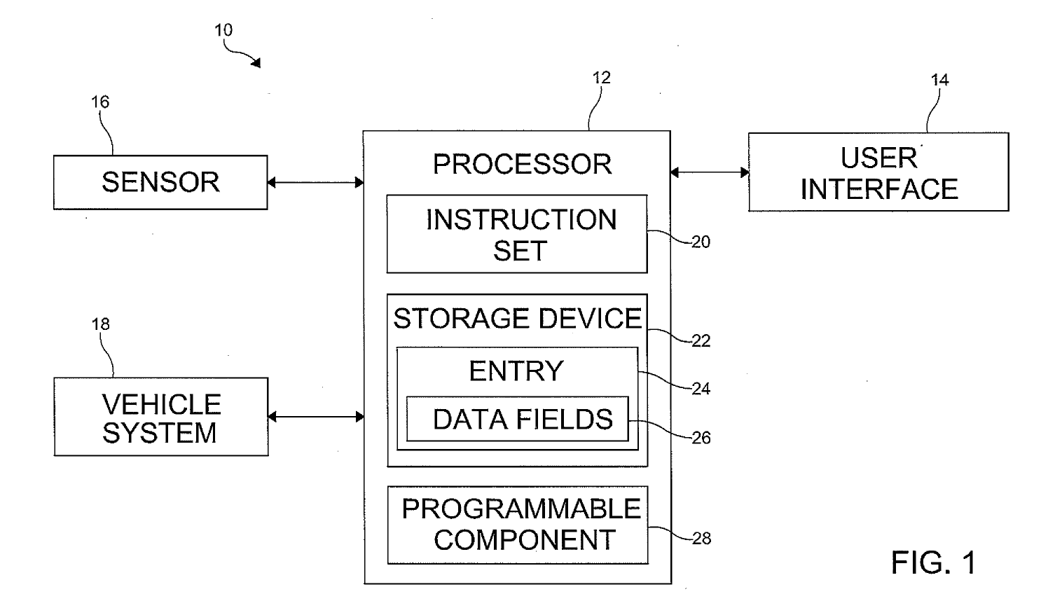

FIG. 1 illustrates an adaptive interface system 10 according to an embodiment of the present invention. As shown, the interface system 10 includes a processor 12 and a user interface 14. The interface system 10 can include any number of components, as desired. As a non-limiting example, the interface system 10 is disposed in a vehicle (not shown). However, the interface system 10 can be integrated in any user environment.

The processor 12 may be any device or system adapted to receive a data signal, analyze and evaluate the data signal, and configure the user interface 14 in response to the analysis and evaluation of the data signal. In certain embodiments, the processor 12 is a micro-computer. In the embodiment shown, the processor 12 receives the data signal from at least one of a sensor 16, a vehicle system 18, and a user-provided input via the user interface 14. As a non-limiting example, the sensor 16 is adapted to detect or measure a pre-defined input data such as a global position, a vehicle speed, a seat position, a time, a date, a temperature, a moisture, and an external light intensity. The sensor 16 can be any device and can detect any parameter, vehicle condition, environmental condition, and user characteristic, as desired. As a further example, the vehicle system 18 can be any system or device such as a navigation system, an electronic control module, a radio, an infotainment unit, and a communication device adapted to connect to the Internet. It is understood that the processor 12 may be in communication with and may provide control of other devices, systems and components.

As shown, the processor 12 analyzes and evaluates the data signal based upon an instruction set 20. The instruction set 20, which may be embodied within any computer readable medium, includes processor executable instructions for configuring the processor 12 to perform a variety of tasks. It is understood that the processor 12 may execute a variety functions such as controlling the functions of the sensor 16, the vehicle system 18, and the user interface 14, for example. As a non-limiting example, the instruction set 20 is a learning algorithm adapted to determine the habitual actions and preferences of the user based upon the information received by the processor 12 (e.g. via the data signal). As a further example, the instruction set 20 is used to categorize a particular trigger event based upon the information received by the processor 12 at the time the event occurred. It is further understood that the trigger event can be any event or condition related to the vehicle, the user, the environment, and any other detectable condition.

In certain embodiments, the processor 12 includes a storage device 22. The storage device 22 may be a single storage device or may be multiple storage devices. Furthermore, the storage device 22 may be a solid state storage system, a magnetic storage system, an optical storage system or any other suitable storage system or device. It is understood that the storage device 22 is adapted to store the instruction set 20. Other data and information may be stored and cataloged in the storage device 22 such as the data collected by the user interface 14, the sensor 16 and the vehicle system 18, for example.

In certain embodiments, each time the user interacts with the user interface 14, an entry 24 is created in the storage device 22. The entry 24 includes a plurality of data fields 26 populated with the information received by the processor 12, wherein the entry 24 is associated with the particular trigger event. For example, every weekday morning between six o'clock and seven o'clock the user tunes a radio in the vehicle to a particular preset (e.g. a favorite morning show). Accordingly, the entry 24 for the trigger event includes information such as the date, the time, and the radio preset. As a further non-limiting example, on weekday mornings when the weather is rainy, the user programs the navigation system to monitor traffic conditions. In this example, the entry 24 includes information such as the date, the time, the weather conditions, and the settings of the navigation system. It is understood that any number of data fields 26 may be included and any number of entries may be created. It is further understood that any event may trigger a creation of the data entry 24 in the storage device 22. In certain embodiments, the triggering events are prioritized based upon a pre-defined scheme or a user-provided input.

The processor 12 may further include a programmable component 28. It is understood that the programmable component 28 may be in communication with any other component of the interface system 10 such as the sensor 16, the vehicle system 18, and the user interface 14, for example. In certain embodiments, the programmable component 28 is adapted to manage and control processing functions of the processor 12. Specifically, the programmable component 28 is adapted to modify the instruction set 20 and control the analysis of the data signals and information received by the processor 12. It is understood that the programmable component 28 may be adapted to manage and control the sensor 16 and the user interface 14. It is further understood that the programmable component 28 may be adapted to store data and information on the storage device 22, and retrieve data and information from the storage device 22.

The user interface 14 typically includes a display 30 for presenting a visible output to the user. In the embodiment shown, the display 30 is a touch sensitive display (i.e. touch screen) having a plurality of user-engageable buttons 32, 34, 36, 38 presented thereon. Each of the buttons 32, 34, 36, 38 is associated with an executable function.

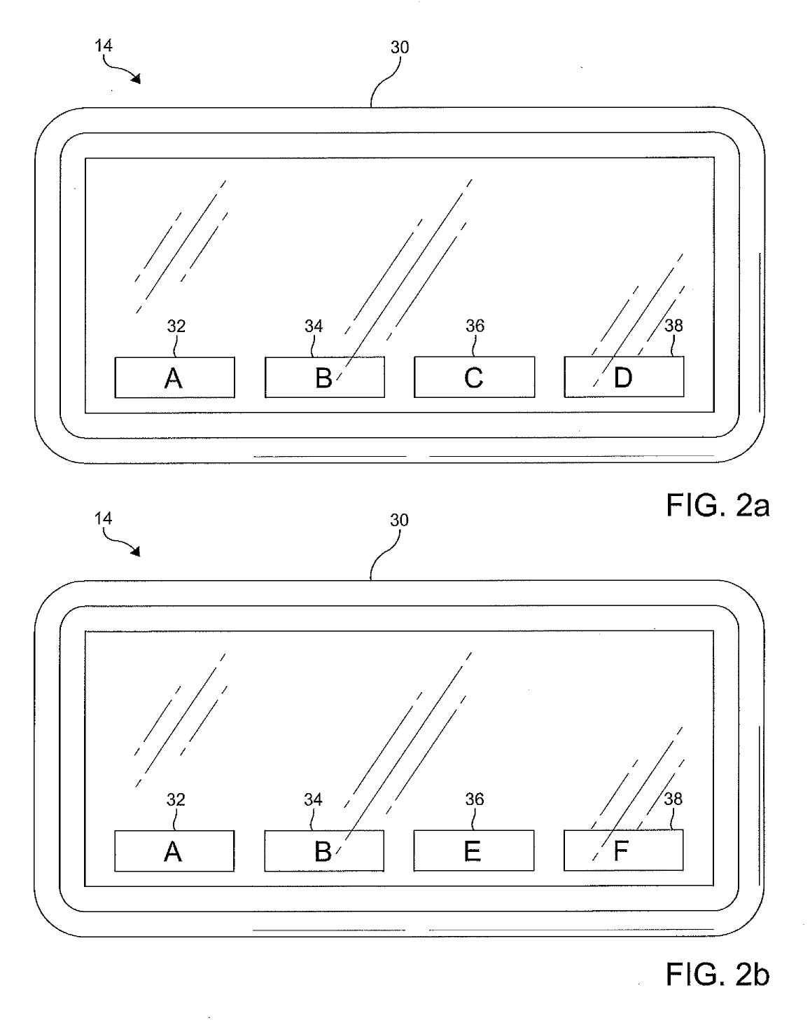

A default configuration of the display 30 is shown in FIG. 2a. As shown, the first button 32 is associated with function “A”, the second button 34 is associated with function “B”, the third button 36 is associated with function “C”, and the fourth button 38 is associated with function “D”. As a non-limiting example, the executable functions are associated with the vehicle system 18, wherein each of the executable functions represents a control option for the particular vehicle system 18. However, each of the buttons 32, 34, 36, 38 can be associated with a different system or device. It is understood that the buttons 32, 34, 36, 38 can be associated with an executable function of any system or device in signal communication with the interface system 10. As a non-limiting example, each of the buttons 32, 34, 36, 38 is associated with a radio channel preset. As a further example, each of the buttons 32, 34, 36, 38 is associated with a configurable setting of the navigation system.

In operation, the user interacts with the interface system 10 in a conventional manner. The processor 12 continuously receives data signals and information relating to pre-determined trigger events. The processor 12 analyzes the information based upon the instruction set 20 to determine a preference of the user. In certain embodiments, the processor 12 evaluates and classifies each of the entries 24 based upon the information populating the data fields 26. The classification and frequency of each of the entries 24 can be used to determine a preference of the user in a particular trigger event. Accordingly, when an event is detected by the processor 12, the user interface 14 is automatically reconfigured based upon the preference of the user for the particular trigger event. Once the preference is determined, the processor 12 automatically configures at least one of the visible output presented on the display 30 and an executable function associated with the visible output (e.g. the buttons 32, 34, 36, 38) presented on the display 30, based upon the preference of the user. The processor 12 thereby automatically generates a personalized configuration of the elements associated with the user interface 14.

For example, each time the vehicle is operated at night, the user lowers an intensity of a backlighting of the display 30 and plays an audio output based upon a playlist downloaded from the Internet. Therefore, when the user is operating the vehicle at night, the processor 12 automatically lowers the intensity of the backlighting of the display 30 and connects to the Internet to download a playlist and generate an audio output based upon the playlist.

It is understood that the user can manually modify the configuration of the display 30 and the executable functions and associate the particular configuration with a particular trigger event. For example, the user can create a personalized configuration that is generated by the user interface 14 each time the navigation system is programmed for a trip having a travel time greater than one hour. It is further understood that the user interface 14 may provide a selective control over the automatic reconfiguration of the display 30. For example, the display 30 may always revert to the default configuration unless the user initiates a suggestion mode, wherein the display 30 automatically reconfigures to the personalized configuration associated with the present trigger event. The user interface 14 can be configured based on any trigger event. For example, once one of the entries 24 representing a trigger event exceeds a particular threshold, the processor 12 reconfigures the user interface 14 to more accurately represent a real-time preference, a routine, or a habitual action of the user.

An example of the personalized configuration is shown in FIG. 3b. As shown, the first button 32 is associated with function “A”, the second button 34 is associated with function “B”, the third button 36 is associated with function “E”, and the fourth button 38 is associated with function “F”. Accordingly, the processor 12 reconfigured the executable functions associated with the third button 36 and the fourth button 38, as compared to the default configuration. The personalized configuration shown in FIG. 2b is automatically generated in response to a particular trigger event.

The interface system 10 and methods of configuring the user interface 14 provide a real-time personalization of the user interface, thereby minimizing the time and direct attention needed to navigate through the most commonly used functions of the user interface 14 for any given instance or event.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An adaptive interface system comprising:
a user interface having a display; and
a processor receiving a data relating to a pre-determined trigger event, analyzing the data based upon an instruction set to determine a preference of a user, and reconfiguring the display based upon the preference of the user.

2. The interface system according to claim 1, wherein the display of the user interface is a touch screen.

3. The interface system according to claim 1, wherein the reconfiguring the display includes associating a particular executable function with the display.

4. The interface system according to claim 3, wherein the executable function is associated with a vehicle system.

5. The interface system according to claim 3, wherein the display includes a user-engageable button associated with the executable function.

6. The interface system according to claim 1, wherein the data is received from at least one of a sensor, a user-provided input, and a vehicle system.

7. The interface system according to claim 1, wherein the reconfiguring the display is selectively initiated based upon a pre-determined user-provided input.

8. The interface system according to claim 1, wherein the reconfiguring the display includes a modification to a visual output presented thereon.

9. An adaptive interface system comprising:
a user interface having a display;
a storage device cataloging a data relating to a predetermined event; and
a processor receiving the data relating to the pre-determined trigger event, analyzing the data based upon an instruction set to determine a preference of a user, and reconfiguring the display based upon the preference of the user.

10. The interface system according to claim 9, wherein the display of the user interface is a touch screen.

11. The interface system according to claim 9, wherein the reconfiguring the display includes associating a particular executable function with the display.

12. The interface system according to claim 11, wherein the executable function is associated with a vehicle system.

13. The interface system according to claim 11, wherein the display includes a user-engageable button associated with the executable function.

14. The interface system according to claim 9, wherein the data is received by the processor from at least one of the storage device, a sensor, a user-provided input, and a vehicle system.

15. The interface system according to claim 9, wherein the reconfiguring of the display is selectively initiated based upon a pre-determined user-provided input.

16. The interface system according to claim 9, wherein the reconfiguring of the display includes a modification to a visual output presented thereon.

17. The interface system according to claim 9, wherein the data is cataloged in the storage device as entries having pre-defined data fields.

18. A method of configuring a user interface, the method comprising the steps of:
providing a means for collecting a data relating to a pre-determined trigger event; and
providing a processor to receive the data, analyze the data based upon an instruction set to determine a preference of a user, and reconfigure the user interface based upon the preference of the user.

19. The method according to claim 18, wherein the reconfiguration of the user interface includes a modification to a visual output generated thereby.

20. The method according to claim 18, wherein the reconfiguration of the user interface includes associating a particular executable function therewith.
